(19) United States
(12) Patent Application Publication
(10) Pub. No.: US 2010/0208477 A1
(43) Pub. Date: Aug. 19, 2010

(54) ATTACHMENT SYSTEM FOR GLASS LIGHT FIXTURES

(76) Inventor: Scott Derrall Chambers, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/707,241

(22) Filed: Feb. 17, 2010

Related U.S. Application Data
(60) Provisional application No. 61/153,432, filed on Feb. 18, 2009.

(51) Int. Cl. F21V 17/06

(52) U.S. Cl. 362/433

(57) ABSTRACT

An attachment for light fixture lenses is provided that includes a support member having at least one elongate extension with a distal end and a proximal end, the distal end having a distal tip; a first retaining member mounted on the distal end of the at least one elongate extension for selective positioning along a longitudinal axis of the at least one elongate extension; and a second retaining member mounted on the distal tip of the at least one elongate extension for selective positioning along the longitudinal axis of the at least one elongate extension, the second retaining member cooperating with the first retaining member to clamp the lens at a selected location on the distal end of the support member.

### BACKGROUND

1. Technical Field

The present disclosure is directed to hand-blown glass light fixture lenses and, more particularly, to an attachment system that provides for adjustable and secure attachment of glass light fixture lenses to a structural support.

2. Description of the Related Art

Hand-blown glass light fixtures generally have one of more glass lenses mounted to a supporting structure that also can include one or more electrical illumination devices, such as incandescent lamps, fluorescent lamps, and the like. In some designs, multiple glass lenses are positioned around a single lamp for decorative purposes. Each glass lens is separately mounted to the supporting structure.

Hand-blown glass can be extremely expensive to manufacture because of the artisanship and time required to prepare the glass and decorative effects. While in some cases the glass can be fragile, in other cases it can be thick and quite heavy. In either case the glass must be carefully mounted so that it is adequately supported. Frequently, to ensure the positioning of the glass lens is functionally and artistically correct, it is desirable to enable selective positioning of the lens on the support structure.

### BRIEF SUMMARY

In accordance with one embodiment of the present disclosure, an attachment system for light fixture lenses is provided. The system includes a support member having at least one elongate extension with a distal end and a proximal end, the distal end having a distal tip; a first retaining member mounted on the distal end of the at least one elongate extension for selective positioning along a longitudinal axis of the at least one elongate extension; and a second retaining member mounted on the distal tip of the at least one elongate extension for selective positioning along the longitudinal axis of the at least one elongate extension, the second retaining member cooperating with the first retaining member to clamp the lens in position on the distal end of the support member.

In accordance with another aspect of the present disclosure, the attachment system includes a sleeve mounted on the distal end of the support member. Ideally the sleeve is formed of compliant material to protect the lens from damage when mounted on the support member and, in another embodiment, has a tight fit over the threads yet can move across the threads when urged by one or both of the retaining members.

In accordance with another aspect of the present disclosure, the distal end of the support member is threaded, and the first and second retaining members are internally threaded to be engaged on the support member. Ideally a compliant washer is received over the rod to bear against the second retaining member and the lens when mounted on the support member.

In accordance with another aspect of the present disclosure, the support member includes a metal rod having external threads on the distal end; the first retaining member comprises a cone-shaped nut having an internal longitudinal axial bore that is threaded to be threadably received on the distal end of the support member with the base of the cone-shaped nut facing towards the distal tip; the second retaining member comprises a decorative member having an internal cap nut for threadable engagement on the distal end of the rod and to prevent the rod from damaging the decorative member when threadably received to its full extent on the distal end of the support member; and further comprising a sleeve formed of a tubular plastic material having a cylindrical shape of uniform external diameter with a hollow longitudinal axial bore sized and shaped to be slidably received over the threads on the distal end of the support member. In accordance with another aspect of the present disclosure, a light fixture is provided, the light fixture including at least one electrical light bulb socket; at least one glass light fixture lens; and a support member having at least one elongate extension with a distal end and a proximal end, the distal end having a distal tip; a first retaining member mounted on the distal end of the at least one elongate extension for selective positioning along a longitudinal axis of the at least one elongate extension; and a second retaining member mounted on the distal tip of the at least one elongate extension for selective positioning along the longitudinal axis of the at least one elongate extension, the second retaining member cooperating with the first retaining member to clamp the lens in position on the distal end of the support member.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an isometric view of a support structure for a plurality of hand-blown glass light fixture lenses;

FIG. 2 is an isometric view of an assembled glass light fixture using the support structure of FIG. 1;

FIG. 3 is an isometric view of an alternative embodiment of the present disclosure illustrating a single support rod with mounting apparatus formed in accordance with the present disclosure;

FIG. 4 is an exploded side view of the components of the embodiment of FIG. 3; and

FIG. 5 is a cross-sectional view of a glass nut used in the embodiments of FIGS. 1-4.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with light fixtures, including but not limited to sockets, wiring, and switches have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

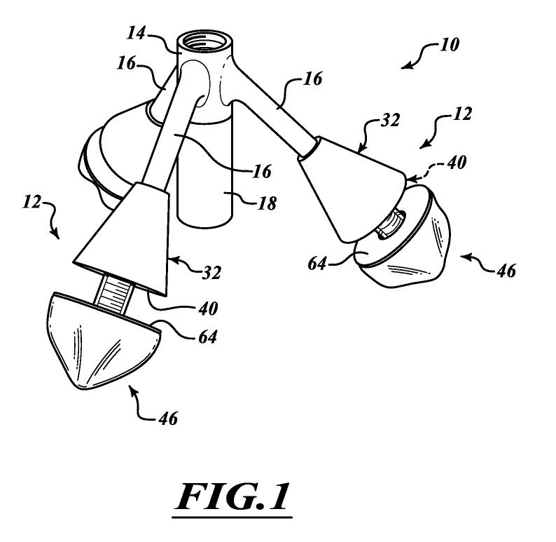

Referring initially to FIG. 1, shown therein is a light fixture assembly 10 having an attachment system 12 formed in accordance with the present disclosure. The light fixture 10 has a central support 14 with a plurality of support members 16 extending therefrom. In this embodiment the central support 14 has a circular cross-sectional configuration with a longitudinal axis extending vertically as shown in FIG. 1. Coaxial with the central support 14 is a cylindrical tube 18 extending downward from the central support 14 as shown in FIG. 1. The tube 18 may be a socket used to mount an incandescent or fluorescent lamp or other illuminating device. Alternatively, the tube 18 may be integrally formed with the central support 14, and there may be a longitudinal axial bore formed therethrough that is threaded to accept a mounting rod or other mounting member to affix the light fixture assembly 10 to a structure, such as a ceiling or a support base.

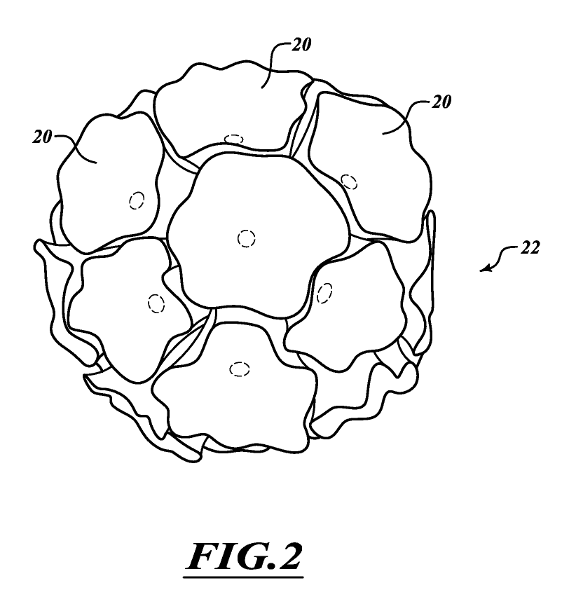

Each of the support members 16 extending from the central support 14 includes the attachment system 12 formed in accordance with the present invention. Although the embodiment shown in FIG. 1 has the support members 16 integrally formed with the central support 14, it is to be understood that each support member 16 can be individually attached or mounted to the central support 14 such that the support member 16 can be removed and replaced. Each support member 16 is configured to support at least one light fixture lens 20, as shown more particularly in FIG. 2. In the embodiment shown in FIG. 2, a globe-like light fixture assembly 22 is illustrated in which a plurality of lenses 20 are mounted to a light fixture assembly. In this embodiment, each attachment system 12 on each support member 16 supports a single lens 20.

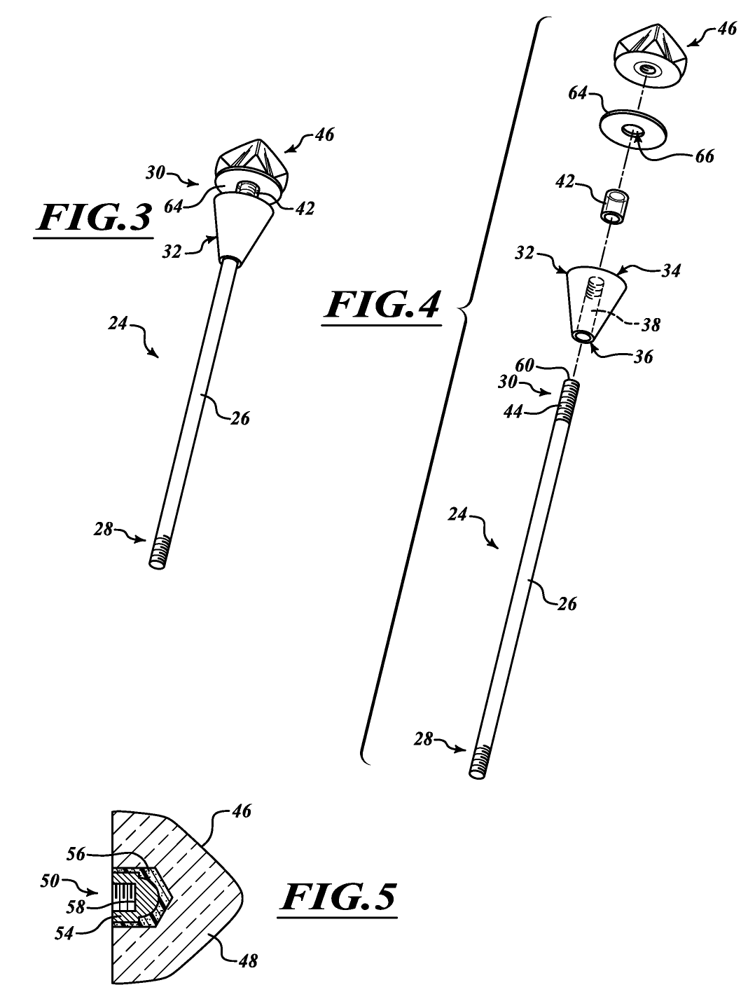

Referring next to FIGS. 3 and 4, shown therein is an alternative embodiment of the attachment system 24 formed in accordance with the present disclosure in which an elongate rod 26 has a proximal end 28 and a distal end 30. In this embodiment, the proximal end 28 is threaded to be removably attached to a central support 14 such as that shown in FIG. 1. Ideally the rod 26 is formed of solid metal, although it is to be understood that it can be formed from other materials so long as it is sufficiently strong to support a corresponding lens. The rod 26 may be straight or have one or more bends.

A first retaining member 32 is shown having a truncated cone shape with an enlarged base 34 and reduced diameter top 36. A longitudinal axial bore 38 is formed therethrough that preferably is threaded so as to be threadably engaged with the distal end 30 of the rod 26. The bottom face 40 of the first retaining member 32 is planar and formed at substantially a right angle or orthogonal to the longitudinal axis of the bore 38. Ideally the first retaining member 32 is also formed from metal, although it may be formed from other materials to accomplish its purpose.

In one embodiment, the first retaining member 32 has threads that extend from the bottom face 40 to approximately halfway through the bore 38. This allows the first retaining member 32 to be selectively positioned along the rod 26 while the top half of the first retaining member 32 covers up the threaded portion of the distal end 30. This provides a more pleasing appearance when assembled. Consequently, the length of the threaded distal end 30 is also selected to correspond to the length of the first retaining member 32 and the threaded portion of the bore 38. In addition, the size of the first retaining member 32 is selected to provide sufficient support for the size of the lens 20 that is mounted to the rod 26.

A sleeve 42 is positioned over the threaded distal end 30 of the rod 26, preferably with a tight fit, to protect the lens 20 from the sharp threads 44 on the distal end 30 of the rod 26. The sleeve 42 is preferably constructed of a compliant or resilient material that provides some cushioning and protection from the threads for the lens 20, which ideally is formed from glass. Thus, the sleeve 42 is tubular or cylindrical in shape having a hollow longitudinal bore formed therethrough. The sleeve 42 has a uniform external and internal diameter extending along its entire length. The sleeve has a thickness such that a planar surface is formed orthogonal to a longitudinal axis of the sleeve on each end thereof. This surface acts as a shoulder to bear against the bottom face 40 of the first retaining member 32 and a corresponding face on the second retaining member 46 or the washer 64 described below.

The second retaining member 46 is shown in more detail in a cross-sectional view of FIG. 5 to include a decorative glass molding 48 with a longitudinal axial opening formed in a first end 52 thereof. The opening extends partially into the body of the glass molding 48 and is sized and shaped to receive a cap nut 54 therein. Epoxy 56 is used in this embodiment to retain the cap nut 54 in place in the opening 50. The cap nut 54 is internally threaded to be received on the distal end 30 of the rod 26. The cap nut 54 is used because the interior end 58 of the cap nut 54 is closed off or capped, in this way preventing the distal tip of the rod 26 from extending into the decorative glass molding 48 and causing damage or fracturing the molding 48.

As can be seen in FIG. 5, the second retaining member 46 has the first end 52 with a substantially planar face 62 that is formed substantially orthogonal to the longitudinal axis of the opening 50. The planar face 52 is used to bear against the glass lens 28 in cooperation with the bottom face 40 of the first retaining member 32 to essentially clamp the lens 20 between these two members and retain it in its position on the rod 26.

To prevent damage to the lens, a resilient or plastic washer 64 is sized and shaped to bear against the face 62 of the glass molding 48. The washer 64 has an internal opening 66 that is sized to be slid over the distal end 30 of the rod 26 and to be slid over the sleeve 42. In this way the washer 64 is not restricted from bearing against the lens 20 by the sleeve 42. Moreover, the opening 50 in the second retaining member 46 can also be sized at the face 62 to be large enough to allow the sleeve to partially enter the opening 50. Thus, the opening 50 can be counter-bored of a larger diameter than the diameter of the opening 50 used to receive the cap nut 54.

In use, the first retaining member 32 is threadably received onto the rod 26 at the distal end 30. The sleeve 42 is then positioned over the threads 44 a sufficient distance onto the rod 26 to leave enough exposed threads 44 to receive the second retaining member 46. The length of the sleeve 42 is selected to accommodate the particular light fixture lens 20 or glass rhondelle that is to be mounted on the rod 26. The washer 64 is then placed over the distal end 30 followed by the second retaining member 46. The position of the lens 20 along the longitudinal axis of the rod 26 is adjusted by first placing the first retaining member 32 at the location on the rod 26 where the lens is to be positioned. The second retaining member 46 is then threaded onto the rod and tightened down to bear against the lens 20, urging the lens 20 into engagement with the first retaining member 32, thus clamping the lens 20 into position on the rod 26.

While preferred embodiments of the invention have been illustrated and described, it is to be understood that various changes can be made therein without departing from the spirit and scope of the invention. For example, the washer 64 can be adhered to the second retaining member 46 with appropriate adhesive, thus preventing the washer 64 from being lost. In addition, the external diameter of the sleeve 42 can be varied to accommodate openings in the lens 20 so that the lens 20 is seated on the sleeve 42 without undue play or movement on the sleeve 42.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An attachment system for light fixture lenses, comprising:
a support member having at least one elongate extension with a distal end and a proximal end, the distal end having a distal tip;
a first retaining member mounted on the distal end of the at least one elongate extension for selective positioning along a longitudinal axis of the at least one elongate extension; and
a second retaining member mounted on the distal tip of the at least one elongate extension for selective positioning along the longitudinal axis of the at least one elongate extension, the second retaining member cooperating with the first retaining member to clamp the lens in position on the distal end of the support member.

2. The system of claim 1, further comprising a resilient sleeve mounted on the distal end of the support member.

3. The system of claim 2 wherein the sleeve is formed of compliant material and is sized to have a tight fit on the distal end of the support member to protect the lens from damage when mounted on the distal end of the support member.

4. The system of claim 1 wherein the distal end of the support member is threaded, and the first and second retaining members are internally threaded to be threadably received on the support member.

5. The system of claim 1, further comprising a compliant washer formed to be slidably received over the distal end of the support member and to bear against the second retaining member and the lens when the lens is mounted on the support member.

6. The system of claim 1 wherein the support member comprises:
a metal rod having external threads on the distal end;
the first retaining member comprises a cone-shaped nut having an internal longitudinal axial bore that is threaded to be threadably received on the distal end of the support member with the base of the cone-shaped nut facing towards the distal tip;
the second retaining member comprises a decorative member having an internal cap nut for threadable engagement on the distal end of the rod and to prevent the rod from damaging the decorative member when threadably received to its full extent on the distal end of the support member; and
further comprising a sleeve formed of a tubular plastic material having a cylindrical shape of uniform external diameter with a hollow longitudinal axial bore sized and shaped to be slidably received over the threads on the distal end of the support member.

7. The system of claim 1 wherein the sleeve has a thickness that forms a shoulder that bears against the first and second retaining members to limit the distance to which the first and second retaining members can be threadably tightened towards each other.

8. A light fixture, comprising:
at least one electrical light bulb socket;
at least one glass light fixture lens; and
a support member having at least one elongate extension with a distal end and a proximal end, the distal end having a distal tip;
a first retaining member mounted on the distal end of the at least one elongate extension for selective positioning along a longitudinal axis of the at least one elongate extension; and
a second retaining member mounted on the distal tip of the at least one elongate extension for selective positioning along the longitudinal axis of the at least one elongate extension, the second retaining member cooperating with the first retaining member to clamp the lens in position on the distal end of the support member.

9. The system of claim 8, further comprising a resilient sleeve mounted on the distal end of the support member.

10. The system of claim 9 wherein the sleeve is formed of compliant material and having a tight fit on the distal end of the support member to protect the lens from damage when mounted on the distal end of the support member.

11. The system of claim 8 wherein the distal end of the support member is threaded, and the first and second retaining members are internally threaded to be threadably received on the support member.

12. The system of claim 8, further comprising a compliant washer formed to be slidably received over the distal end of the support member and to bear against the second retaining member and the lens when the lens is mounted on the support member.

13. The system of claim 8 wherein the support member comprises:
a metal rod having external threads on the distal end;
the first retaining member comprises a cone-shaped nut having an internal longitudinal axial bore that is threaded to be threadably received on the distal end of the support member with the base of the cone-shaped nut facing towards the distal tip;
the second retaining member comprises a decorative member having an internal cap nut for threadable engagement on the distal end of the rod and to prevent the rod from damaging the decorative member when threadably received to its full extent on the distal end of the support member; and
further comprising a sleeve formed of a tubular plastic material having a cylindrical shape of uniform external diameter with a hollow longitudinal axial bore sized and shaped to be slidably received over the threads on the distal end of the support member.

14. The system of claim 8 wherein the sleeve has a thickness that forms a shoulder that bears against the first and second retaining members to limit the distance to which the first and second retaining members can be threadably tightened towards each other.
